(19) United States
(12) Patent Application Publication
(10) Pub. No.: US 2024/0185658 A1
(43) Pub. Date: Jun. 6, 2024

(54) METHOD AND CLOUD SERVICE FOR ALLOWING REMOTE ACCESS TO SPECIFIC VEHICLE FUNCTIONS

(71) Applicants: Ningbo Geely Automobile Research & Development Co., Ltd., Ningbo (CN); Zhejiang Geely Holding Group Co., Ltd., Zhejiang (CN)

(72) Inventors: Johan SETTERBERG, Göteborg (SE); Jonathan JOHANSSON, Göteborg (SE)

(21) Appl. No.: 18/444,197

(22) Filed: Feb. 16, 2024

Related U.S. Application Data
(63) Continuation of application No. PCT/CN2022/115298, filed on Aug. 26, 2022.

(30) Foreign Application Priority Data
Aug. 30, 2021 (EP) 21193841.0

(51) Int. Cl. G07C 9/00

(52) U.S. Cl. CPC G07C 9/00857; G07C 9/00309; G07C 9/00571; G07C 2009/00507; G07C 2009/00865

(57) ABSTRACT

A method for allowing remote access to specific vehicle functions of a vehicle includes: —receiving information from a vehicle owner/user that a specific service of the vehicle is requested, —in response to the requested specific service, creating a new digital key or authenticating an existing digital key for a vehicle service provider, which provides the specific service requested, wherein the digital key comprises information arranged to allow remote access to a subset of a plurality of specific vehicle functions, or a vehicle service user using the specific service requested, which subset is associated with the specific service of the vehicle, —allowing operation of the subset of specific vehicle functions by the vehicle service provider for performing the specific service or by the vehicle service user using the specific service if the digital key is received.

### RELATED APPLICATION DATA

This application is a continuation of International Patent Application No. PCT/CN2022/115298, filed Aug. 26, 2022, which claims the benefit of European Patent Application No. 21193841.0, filed Aug. 30, 2021, the disclosures of which are incorporated herein by reference in their entireties.

### TECHNICAL FIELD

The disclosure relates to a method and a cloud service for allowing remote access to specific vehicle functions of a vehicle.

### BACKGROUND

Today's vehicles are normally adapted to be able to be accessed remotely in order to operate specific functions, for instance for performing specific services such as deliveries and cleaning. A physical or digital key is associated with the car and allows the holder of the digital key to access the vehicle's functions. One problem with today's solution is that the digital key provides access to all of the vehicle's functions even if some functions are not necessary to operate to perform the specific service. Further, it is difficult to allow access for new users as the digital keys are normally created during production of the vehicle or linked to a specific user account that cannot easily be shared.

### SUMMARY

An objective of the disclosure is to provide a method and a cloud service addressing the issues raised.

The disclosure relates to a method for allowing remote access to specific vehicle functions of a vehicle, wherein the method comprises:
receiving information from a vehicle owner/user that a specific service of the vehicle is requested,
in response to the requested specific service, creating a new digital key or authenticating an existing digital key for a vehicle service provider, which provides the specific service requested, or a vehicle service user using the service requested, wherein the digital key comprises information arranged to allow remote access to a subset of a plurality of specific vehicle functions, which subset is associated with the specific service of the vehicle,
allowing operation of the subset of specific vehicle functions by the vehicle service provider for performing the specific service or the vehicle service user if the digital key is received.

One advantage with the method according to the disclosure is that it allows a vehicle service provider access to one or more specific vehicle functions of a vehicle, i.e. a subset of a plurality of specific vehicle functions, which can be remotely accessed in order for the vehicle service provider to perform a specific service. Alternatively, the method allows a vehicle service user access to one or more specific vehicle functions of a vehicle, i.e. a subset of a plurality of specific vehicle functions, which can be remotely accessed in order for the vehicle service user to be able to use a specific service.

Today, access is granted to all of the vehicle's functions even though access to only a select few functions may be required to perform a specific service or use a specific service. Either the method allows for the creation of a new digital key or for the authentication of an existing digital key of a vehicle service provider or a vehicle service user where the digital key comprises information arranged to allow remote access to a subset of a plurality of specific vehicle functions. Authentication of an existing digital key may be used for a recurring service provided by the same vehicle service provider that once has had a digital key created for it, for a vehicle service user accessing a recurring specific service or for a service provider (e.g. service drone) using a digital key in the form of a unique code in an NFC chip or any other static identifier. Examples are for instance found in US 2018/0126951 A1 and US 2018/0148016 A1. In the last use case the service provider will only transmit not receive any information from the vehicle cloud and the meta-data about the inbuilt key could be added to the car to pre-authenticate the existing key. Once the digital key is received by the vehicle, the vehicle service provider or vehicle service user is allowed to operate the subset associated with the specific service of the vehicle for which it has been granted access.

The digital key can comprise information on who the vehicle service provider or vehicle service user is and adapts the access depending on who the digital key has been created or authorized for and for what service or use of the vehicle is ordered. For instance, the access will be different for an adult driver or a student driver.

By allowing or restricting access according to the method, ways to save lives, avoid theft, mitigate or remove the effects of unwanted events, improved usage, improved safety and reducing or completely preventing unwanted behaviour is provided.

The method may further comprise:
restricting operation of the subset of specific vehicle functions by the vehicle service provider or the vehicle service user to a specific part of the vehicle. Some services takes place in a specific part of the vehicle, such as the luggage compartment or the passenger compartment. The method may allow for restriction of operation of the subset of specific vehicle functions to these specific parts. As a non-limiting example, operating the interior lights of the vehicle may be restricted to only the luggage compartment or the passenger compartment, but not both. Another example may be that when car sharing or using a driverless taxi, only functions relating to the specific seat connected to the vehicle service user that has requested transportation in that specific seat may be accessed.

The method may further comprise:
changing dynamically the subset of specific vehicle functions that is allowed to be operated by the vehicle service provider for performing the specific service or by the vehicle service user, and/or
changing dynamically the subset of specific vehicle functions that is restricted to be operated by the vehicle service provider or vehicle service user to a specific part of the vehicle. Depending on if the situation the vehicle is in changes, access to the subset of specific vehicle functions that a vehicle service provider or vehicle service user is allowed to operate or that is restricted to be operated can be changed dynamically. For instance, a vehicle service user may be allowed to operate a vehicle at any speed (within legal speed limits) outside of an urban area. As soon as the vehicle enters the urban area, the top speed is capped at the highest speed allowed within the urban area.

The method may further comprise:
allowing operation of a specific vehicle function of the subset of specific vehicle functions associated with a safety check by a vehicle function access device only if the safety check is passed upon requesting access to the specific vehicle function. Some services may require moving of vehicle parts such as opening the door of the vehicle that is to receive the vehicle service. Depending on if a safety check by a vehicle function access device is passed upon requesting access to the specific vehicle function, the vehicle service provider or the vehicle service user will be allowed to operate the specific vehicle function. As a non-limiting example, if the specific service requires the opening of a vehicle door, the opening is only allowed to take place if the safety check ensures that the vehicle door can be opened without risk of a foreign object or a person getting in the way of the door.

The method may further comprise:
assessing if the safety check is passed based on sensor feedback from one or more sensors arranged in the vehicle or on a vehicle service provider, wherein the sensor feedback is one or more of detection of a foreign object inside the vehicle, detection of a foreign object outside the vehicle or detection of a vehicle occupant. In order to ensure that no damage is done, either to the vehicle itself, to a foreign object in the vehicle or to a vehicle occupant, either the vehicle's own internal or external sensors, sensors arranged on a vehicle service provider or both may provide sensor feedback in response to a request for access to a specific vehicle function. If the sensor feedback returns detection of one or more of a foreign object inside the vehicle, a foreign object outside the vehicle or a vehicle occupant, the safety check will fail and operation of the specific vehicle function will not be allowed. Such sensor feedback may be relayed to for instance the vehicle owner or to the vehicle service provider operator. This allows the vehicle owner or the vehicle service provider operator to take action and see to that the foreign object inside the vehicle, the foreign object outside the vehicle or the vehicle occupant is removed such that the specific vehicle function can be accessed and the vehicle service performed.

The method may further comprise:
assessing if the safety check is passed based on detecting a safe location of the vehicle service provider or the vehicle service user in an area inside the vehicle or outside the vehicle associated with the specific vehicle function. The safety check may alternatively or complementary include verification that the vehicle service provider or the vehicle service user is in an area where it is safe for it to operate a specific vehicle function. As a non-limiting example, in order for a vehicle service provider to be allowed to move the vehicle's seats, the vehicle service provider must be in area where it cannot be affected by the movement of the seats. This can for instance mean that it has to be detected that the vehicle service provider is located outside of the vehicle or in the luggage compartment of the vehicle before the seats can be moved.

The method may further comprise:
providing the new digital key or existing digital key with information regarding a location associated with the specific service of the vehicle,
allowing operation of the subset of specific vehicle functions associated with the vehicle service provider or the vehicle service user only if the vehicle is determined to be in the location associated with the specific service of the vehicle. In order to ensure that the vehicle is not removed from a place where a specific service is intended to take place, operation of specific vehicle functions may have as a condition that the vehicle is in a location associated with the specific service of the vehicle. As a non-limiting example, the vehicle service may be delivery of goods to a parked vehicle. As long as the vehicle is determined to be in the specific place where the delivery is arranged to take place, such as a parking lot, a vehicle service provider is allowed to perform the specific vehicle functions needed to perform the delivery or the vehicle service user entering an unmanned taxi, such as unlocking and opening one or more of the vehicle's doors. If the vehicle service provider were to approach the vehicle outside of the location associated with the delivery of goods, the vehicle service provider would not be allowed to unlock and open the vehicle's doors.

The method may further comprise:
providing a time limit for expiration of the new digital key or existing digital key,
deactivating the new digital key or existing digital key upon expiration of the time limit. In order to ensure that access to a specific vehicle function is not unlimited and can thereby be misused, either wilfully or unintentionally, a time limit for expiration of the digital key can be set. After the expiry of the time limit, the digital key is deactivated and needs to be authenticated again before it can be allowed access to specific vehicle functions.

The method may encompass that the vehicle service provider is an autonomous unit, such as an unmanned aerial vehicle (UAV), an unmanned wheeled vehicle or an unmanned tracked vehicle. The method is suitable for autonomous units, also known as drones, which can provide vehicle services. The autonomous unit can have different designs depending on the specific vehicle service that is to be performed. One autonomous unit can perform the vehicle service. Alternatively, a multitude of autonomous units of different design in cooperation can perform the vehicle service. The vehicle service may also be performed by human vehicle service providers or by a combination of human vehicle service providers and autonomous units.

The method may encompass that each autonomous unit receives a different digital key or the car authenticating an existing digital key broadcasted by the autonomous unit comprising information arranged to allow access to a different subset of specific vehicle functions associated with each autonomous unit. Depending on the vehicle service to be performed, individual access can be set to the individual autonomous units performing the vehicle service. In this way, no individual autonomous unit is granted access to specific vehicle functions not required for that individual autonomous unit to perform its specific part of the vehicle service. This will ensure that several autonomous units can work efficiently to perform the vehicle service. This of course also applies to the situation where multiple human vehicle service providers will perform the vehicle service or to the situation where a combination of autonomous units and human vehicle service providers perform the vehicle service.

Operation of specific vehicle functions may include one or more of:
mechanically moving a vehicle component such as a door, window, retractable roof or hardtop, sunroof, hatch, or seat,
activating a specific vehicle function, such as a vehicle lock, a vehicle disinfection program, a vehicle cleaning program, an infotainment system, an air conditioning system and a vehicle sensor. This is to be seen as a non-limiting list of example specific vehicle functions. Other specific vehicle functions that are associated with performing vehicle services are also conceivable within the scope of the method.

The method may further comprise:
sending the new digital key or authentication of the existing digital key by a vehicle access management system to a communication device associated with the vehicle service provider or the vehicle service user,
sending the new digital key or authentication of the existing digital key by a telematics service provider to a vehicle function access device in the vehicle,
verifying in the vehicle function access device that the new digital key or existing digital key allows operation of the subset of specific vehicle functions by the vehicle service provider or by the vehicle service user. This is one non-limiting example of how the method can be implemented.

The disclosure also relates to a cloud service for providing remote access to specific vehicle functions of a vehicle, wherein the cloud service is configured for:
receiving information from a vehicle owner/user that a specific service of the vehicle is requested,
in response to the requested specific service, creating a new digital key or authenticating an existing digital key for a vehicle service provider or a vehicle service user, which provides the specific service requested, wherein the digital key comprises information arranged to allow remote access to a subset of a plurality of specific vehicle functions, which subset is associated with the specific service of the vehicle,
providing the vehicle service provider or the vehicle service user with the new digital key or authentication of an existing digital key, allowing operation of the subset of specific vehicle functions by the vehicle service provider for performing the specific service or by the vehicle service user using the specific service if the digital key is received. Similar to the method as described above, the cloud service according to the disclosure provides the same advantages.

The cloud service may further be configured for:
providing information arranged to allow remote access to a subset of a plurality of specific vehicle functions, wherein the operation of the subset of specific vehicle functions by the vehicle service provider or the vehicle service user is restricted to a specific part of the vehicle.

The cloud service may further be configured for:
changing dynamically the subset of specific vehicle functions that is allowed to be operated by the vehicle service provider for performing the specific service or by the vehicle service user, and/or
changing dynamically the subset of specific vehicle functions that is restricted to be operated by the vehicle service provider or the vehicle service user to a specific part of the vehicle.

The cloud service may further be configured for:
when creating a new digital key for the vehicle service provider or the vehicle service user,
   sending the new digital key or authentication of the existing digital key by a vehicle access management system to a communication device associated with the vehicle service provider or the vehicle service user,
   sending the new digital key or authentication of the existing digital key by a telematics service provider to a vehicle function access device in the vehicle,
   verifying in the vehicle function access device that the new digital key or existing digital key allows operation of the subset of specific vehicle functions by the vehicle service provider or the vehicle service user.

The specific service of the vehicle may include one or more of:
package delivery,
food delivery,
cleaning of the vehicle,
charging of the vehicle,
wheel change,
parking,
rental car relocation. This is to be seen as a non-limiting list of examples that the specific service can encompass. Other specific services are conceivable within the context of the disclosure.

### BRIEF DESCRIPTION OF THE DRAWINGS

FIG. 1 schematically shows a method flowchart according to a first example embodiment of the disclosure,

FIG. 2 schematically shows a method flowchart according to a second example embodiment of the disclosure,

FIG. 3 schematically shows a vehicle arranged to allow remote access to specific vehicle functions through communication with a cloud service,

FIGS. 4A and 4B schematically show a top view of a vehicle arranged to allow remote access to specific vehicle functions through communication with a cloud service, according to two non-limiting example use examples.

### DETAILED DESCRIPTION OF EXAMPLE EMBODIMENTS

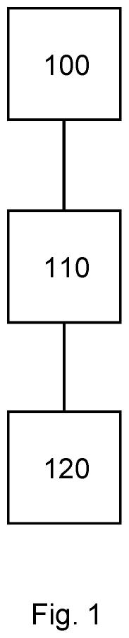

FIG. 1 schematically shows a flowchart over a method according to a first example embodiment of the disclosure. In method step 100, a vehicle owner/vehicle user requests that a specific service should be performed on a vehicle that the vehicle owner/vehicle user manages. Information regarding the request is sent to a vehicle access management system.

In method step 110, in response to the requested specific service, the vehicle access management system creates a new digital key or authenticates an existing digital key for a vehicle service provider, which is intended to provide the specific service requested or for a vehicle service user intended to use the specific service. A digital key may be a code that is downloaded and broadcast from e.g. a phone, key token, smart watch or autonomous vehicle. A digital key may also be a unique code in an NFC chip or any other static identifier. Examples are for instance found in US 2018/0126951 A1 and US 2018/0148016 A1. The digital key comprises information arranged to allow remote access to a subset of a plurality of specific vehicle functions, which subset is associated with the specific service of the vehicle. The digital key access database comprises identification information of static identifiers and a user profile associated with each static identifier, which is the method used for identification. The user profile may for instance include a user type such as service provider autonomous unit, a driver including age or a vehicle service user such as a transportation service user.

Each vehicle service booking is also connected to a key type that will limit the type of vehicle services that will be available, when it is available, for how long it is available, in which geographical location it is available, if specific conditions apply to the vehicle service (e.g. speed limitations, trunk cannot be opened if space is used by another vehicle service provider/vehicle service user) etc.

The remote access can work in many different ways. E.g., a vehicle service management system at a remote location can control the vehicle functions remotely and uses an autonomous vehicle present in or near the car to perform the vehicle service. Alternatively, the autonomous vehicle directly steers the vehicle function near or inside the car without assistance from a remote location. The difference between the two examples is that in the first example, control of the vehicle functions are performed from outside of the car, while in the second example direct interaction (e.g. pressing a button, accessing menu options, operating a lever etc.) with the vehicle controls inside the car is used.

In method step 120, the digital key is presented to the vehicle, for instance by means of operating a digital key fob, using an app in network communication with the vehicle where the digital key is stored or by approaching the vehicle carrying a physical token where the digital key is stored with a technology according to digital keyless operation of vehicles as is known today. If the vehicle receives the digital key and it is deemed to contain the correct information regarding the requested access for the vehicle service, operation of the subset of specific vehicle functions by the vehicle service provider for performing the specific service or by the vehicle service user using the specific service is allowed.

The specific service of the vehicle includes one or more of:
package delivery,
food delivery,
cleaning of the vehicle,
charging of the vehicle,
wheel change,
parking,
rental car relocation.

Examples of operation of specific vehicle functions include one or more of:
mechanically moving a vehicle component such as a door, window, retractable roof or hardtop, sunroof, hatch, or seat,
activating a specific vehicle function, such as a vehicle lock, a vehicle disinfection program, a vehicle cleaning program, an infotainment system, an air conditioning system or a vehicle sensor. Operation of a specific vehicle function is initiated by an electronic module associated with the specific vehicle function and performed in the same way as if it was accessed by a vehicle occupant.

The vehicle disinfection program may e.g. include activation of a UV-light, a disinfection spray, evacuation of remaining disinfectant or air conditioning. A vehicle-cleaning program may e.g. include activation of a cleaning spray and evacuation of remaining cleaning spray. The infotainment system can be arranged to provide communication to a vehicle occupant, via video, image and/or sound messages. Vehicle sensors can for instance be interior or exterior cameras, radars, LIDARs, microphones, weight sensors, ultrasonic sensors or heartbeat sensors. Other specific vehicle functions can be to connect/disconnect charging of the vehicle at a charging station, to enable wireless charging pad or to remote control of the vehicle, granting access to vehicle as well as controlling the vehicle remotely.

In the information regarding the request for a specific service to be performed, restrictions that operation of the subset of specific vehicle functions by the vehicle service provider or the vehicle service user can only be performed in a specific part of the vehicle can be included. For instance, if the specific service is cleaning of the inside of the vehicle, restrictions can be put such that operation of only the vehicle doors leading to the passenger compartment can be operated but not the trunk or the hood.

Access to a subset of specific vehicle functions/restrictions of specific vehicle functions can be made dynamically, where access/restriction change dependent on different circumstances. Non-limiting examples include if the vehicle service provider is an autonomous unit or a human service provider, if the vehicle service user is an adult or a child such as a student driver. Other examples include of a child sits in a family vehicle or in a school taxi or school bus. The child's access will change dynamically depending on the vehicle. Yet other examples include a vehicle owner granting access to specific compartments of their vehicle, such as renting out the luggage compartment for deliveries to another person during a specified period. During this time, access to the luggage compartment is restricted to the vehicle owner but granted to the person renting the luggage compartment.

Another example is sharing an autonomous vehicle. If the autonomous vehicle is shared with strangers, one occupant cannot use the vehicle's central lock either to deny access to the vehicle or to deny another occupant to leave the vehicle. Further, access to windows or air conditioning for a specific seat is only given to the occupant. However, when sharing a vehicle with friends, the access is changed so that access to the central lock is granted to everyone.

Other non-limiting examples include if an autonomous unit is allowed access to drive the vehicle remotely but the autonomous unit experiences poor visibility or poor data connectivity with the vehicle. In such instances, the autonomous unit's access to steering and the power unit can be revoked instantaneously and access can be granted again once sight or a stable data connection is achieved. Similarly, if an autonomous unit is allowed access to perform a specific vehicle service inside a vehicle, such as cleaning or delivery, and the autonomous unit experiences poor connectivity with the vehicle, access to the specific vehicle functions that enable the specific vehicle service can be revoked until a stable data connection is achieved.

Based on the above example of connectivity, a connectivity quality factor or connectivity quality indicator can be used to determine access to specific vehicle functions. If the connectivity quality factor or connectivity quality indicator falls below a certain threshold, the vehicle function access device will restrict access to specific vehicle functions according to a priority scale, i.e. the vehicle will automatically prioritize the most important specific vehicle functions that can be accessed safely.

For instance, if the autonomous unit of the above example experiences connectivity with the vehicle in which it is to perform a specific vehicle service that is below a certain connectivity quality factor or connectivity quality indicator, the vehicle function access device will restrict access to the specific vehicle functions that enable the specific vehicle service until the connectivity quality factor or connectivity quality indicator is above a certain threshold. This will for instance ensure that safety checks performed inside the vehicle will be received by the autonomous unit before the specific vehicle service can be provided. For reference, connectivity quality factor or connectivity quality indicator can be likened to the bars displayed on a mobile device that indicates signal strength. Other factors that can affect the connectivity quality factor or connectivity quality indicator can be bandwidth and download/upload speeds. Poor connectivity cannot only be experienced between the vehicle and city infrastructure, but also between the vehicle and an autonomous unit. Both the vehicle and the autonomous unit can report to the other that poor connectivity is experienced, thereby causing a restriction in access to the specific vehicle functions.

A further non-limiting example is in case of an accident, road works or other unplanned events. In cases like these, the access to the vehicle functions can be restricted such that the speed of the vehicle cannot be higher than a prescribed limit to ensure that the vehicle will pass safely. Speed limitation can also be used when passing a school during school hours. Once school hours have passed, the speed limitation can be raised to a higher speed. This happens dynamically without the vehicle user needing to take action.

Another non-limiting example is when police, rescue services or other authorities need to take control over a vehicle, for instance during emergencies or when a vehicle is determined stolen. Today, a signal can be sent to the vehicle to shut down. The method according to the invention will for instance allow the police to issue a command to a stolen vehicle to only be driven to the nearest police station. This means that access to specific vehicle functions that were previously accessible for a driver or an autonomous unit will be restricted dynamically.

From a GDPR/cyber security/privacy perspective, the method according to the invention will provide means to restrict access to data, for instance can access to the vehicle's app and log data be restricted during a vehicle service. Different levels of access can also be provided such as viewing access but editing restrictions.

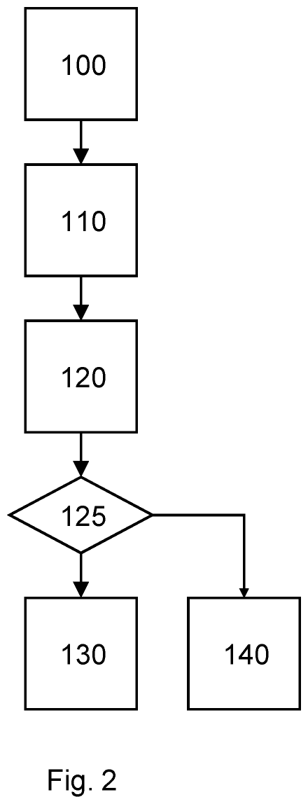

FIG. 2 schematically shows a method flowchart according to a second example embodiment of the disclosure. The method steps 100-120 are the same as described for FIG. 1 but a condition is set on the operation of the subset of the specific vehicle functions. In decision step 125, a safety check is performed by a vehicle function access device upon requesting access to the specific vehicle function. The safety check can either be that the vehicle service provider or the vehicle service user utilizes a car functionality such as an intruder alarm, object detection, child unintentionally left in car warning or similar to check and/or use any sensor equipped on a drone to evaluate if the car or zone inside the car is safe to operate. If the safety check is passed, operation of the specific vehicle function of the subset of specific vehicle functions associated with the safety check by a vehicle function access device is allowed. In method step 130, the safety check in decision step 125 is passed and operation of the specific vehicle function of the subset of specific vehicle functions associated with the specific service of the vehicle is performed. In method step 140, the safety check in decision step 125 is failed and operation of the specific vehicle function of the subset of specific vehicle functions associated with the specific service of the vehicle is not allowed to be performed. The method can revert to decision step 125 if measures are taken by the vehicle service provider or the vehicle service user that can make the safety check to be passed.

The safety check can be assessed to be passed based on sensor feedback from one or more sensors arranged in the vehicle or on the vehicle service provider itself. The sensor feedback is one or more of detection of a foreign object inside the vehicle, detection of a foreign object outside the vehicle or detection of a vehicle occupant. Measures taken to make the safety check to be passed can thus for instance be to remove the foreign object inside the vehicle, remove the foreign object outside the vehicle or ask the vehicle occupant to vacate the vehicle. Sensor feedback can be evaluated by the vehicle service provider itself or be sent to a control function/control room of the vehicle service provider that can provide commands to one or more vehicle service providers to make sure that a safety check can be passed.

Alternatively or complementary, the safety check can be assessed to be passed based on detecting a safe location of the vehicle service provider or the vehicle service user in an area inside the vehicle or outside the vehicle associated with the specific vehicle function. For instance, if the specific service is cleaning the interior of the vehicle, i.e. the luggage compartment and/or the passenger compartment, and the vehicle seats needs to be moved in order to access certain areas in the vehicle interior, the vehicle service provider needs to be outside of the range of motion of vehicle seats in order to remove the risk of damaging the vehicle service provider and/or the vehicle seats. For instance, the vehicle service provider needs to be located outside of the passenger compartment such as outside of the vehicle or inside the luggage compartment in order for the specific vehicle function of moving the vehicle seats can be operated.

Alternative or complementary, the new digital key or existing digital key can be provided with information regarding a location associated with the specific service of the vehicle. Operation of the subset of specific vehicle functions associated with the vehicle service provider or the vehicle service user is allowed only if the vehicle is determined to be in the location associated with the specific service of the vehicle. This information can for instance be made up of a set of GPS coordinates determining an area within which the vehicle must be located in order for the specific service of the vehicle to be performed. The area can for instance be a parking lot, a garage, a workshop or similar. Other alternatives can be distance to drone or observer robot or star satellite communication as described in https://www.extremetech.com/extreme/207624-pulsar-navigation-piloting-aircraft-with-the-aid-of-the-stars.

In order to ensure that the digital key cannot be used for a longer period of time than what is expected to be needed for the specific service of the vehicle to be performed, a time limit for expiration of the new digital key or existing digital key can be provided. The new digital key or existing digital key is deactivated upon expiration of the time limit. If the specific service of the vehicle is not complete, a request for more access time can be made.

Below a number of non-limiting examples of specific services and example subsets of specific vehicle functions associated with the services follows.

### Package Delivery

1. A vehicle owner/vehicle user requests package delivery to vehicle
2. An autonomous unit carrying the package approaches the vehicle
3. The autonomous unit requests opening of the trunk
4. The autonomous unit requests folding of the backseat
5. The autonomous unit delivers the package to the trunk
6. The autonomous unit requests closing of the trunk
7. The autonomous unit marks package as delivered

### Food Delivery

1. A vehicle owner/vehicle user orders food or groceries and selects delivery by an autonomous unit
2. The vehicle owner/vehicle user chooses delivery of warm or cold food
3. The vehicle prepares by automatically starting seat heating or cooling of a compartment before the autonomous unit carrying food delivery arrives
4. The autonomous unit approaches and sends a request to the vehicle to get the location in the vehicle of where to place the food
5. The autonomous unit requests entry to the right location
6. The autonomous unit opens the door leading to the right location, delivers the food and exits
7. The autonomous unit marks the delivery as complete, and the vehicle owner/vehicle user is informed

### Wheel Change

1. The vehicle owner/vehicle user requests a wheel change
2. Authorization is sent to the wheel change service provider
3. An autonomous unit approaches the vehicle and requests remote control over the steering and power unit of the vehicle
4. The vehicle owner/vehicle user or the wheel change service provider receives a camera view of the vehicle and its surroundings from the autonomous unit
5. The vehicle owner/vehicle user or the wheel change service provider remotely drives the vehicle to the wheel change station
6. The vehicle owner/vehicle user or the wheel change service provider enables the vehicle's autopilot to position itself correctly within the wheel change station
7. A wheel change autonomous unit approaches the vehicle and changes the tire
8. The wheel change autonomous unit marks the wheel change complete and the vehicle owner/vehicle user is informed

### Automatic Car Charging

1. The vehicle owner/vehicle user requests a charging service
2. Authorization is sent to the charging service provider
3. An autonomous charging unit approaches the vehicle and requests remote control over the charge lid
4. The autonomous charging unit opens the charge lid and plugs in a power cable
5. The autonomous charging unit removes the power cable and closes the charge lid when the vehicle is fully charged
6. The autonomous charging unit marks the charge complete and the vehicle owner/vehicle user is informed

### Lost Object Detection

1. A vehicle owner/vehicle user is informed that an object has been left in the vehicle by detection of the left object by an in-vehicle camera
2. The vehicle owner/vehicle user requests pickup of the lost object
3. An autonomous unit approaches the vehicle
4. The autonomous unit requests opening of the sun roof
5. The autonomous unit flies in and picks up the lost object
6. The autonomous unit requests closing of the sun roof
7. The autonomous unit delivers the lost object to a pickup location
8. The autonomous unit marks the lost object as retrieved and the vehicle owner/vehicle user can arrange for the lost object to be retrieved

### Vehicle Cleaning

1. The vehicle owner/vehicle user requests cleaning service
2. Authorization is sent to the cleaning service provider and to the car
3. One or more autonomous units approach the vehicle
4. A first autonomous unit requests the vehicle to move the front seats to the forward cleaning position
5. A safety check is performed to ensure that no autonomous unit is inside the vehicle
6. Upon a completed safety check, the front seats are moved to the forward cleaning position
7. A second autonomous unit requests entry through the back seat window
8. The second autonomous unit cleans the back area with a cleaning solution
9. A third autonomous unit requests all windows to lower to allow vaporization
10. The second autonomous unit inside the vehicle exits
11. The first autonomous unit requests the front seat to move into the backwards cleaning position
12. A safety check is performed to ensure that no autonomous unit is inside the vehicle
13. Upon a completed safety check, the front seats are moved to the backwards cleaning position
14. A fourth autonomous unit requests entry through the front seat windows
15. The fourth autonomous unit cleans the front area with a cleaning solution
16. The fourth autonomous unit exits and sends a request to the car to return to its pre-set state with seat positions in the user preference position, windows closed and car locked.
17. A fifth autonomous unit requests passenger compartment refresh for two minutes
18. A sixth autonomous unit sends cleaning complete to the user, authorization for all autonomous units is removed

In the last example, a further autonomous unit can provide sensor feedback by having a camera or another sensor mounted on it. The further autonomous unit can thus only have as a task to provide sensor feedback to ensure that the remaining autonomous units are in a safe location such that a safety check is passed when a specific vehicle function is to be operated.

As is shown in the examples above, even though a number of specific vehicle functions are operated, many specific vehicle functions are not needed to perform the specific service and there is thus no need for a vehicle service provider or the vehicle service user to have access to them to be able to operate them. The method according to the disclosure thereby ensures that a vehicle service provider is granted access only to the subset of specific vehicle functions required to perform the vehicle service and nothing else or alternatively that the vehicle service user is granted access only to the subset of specific vehicle functions required to use the service.

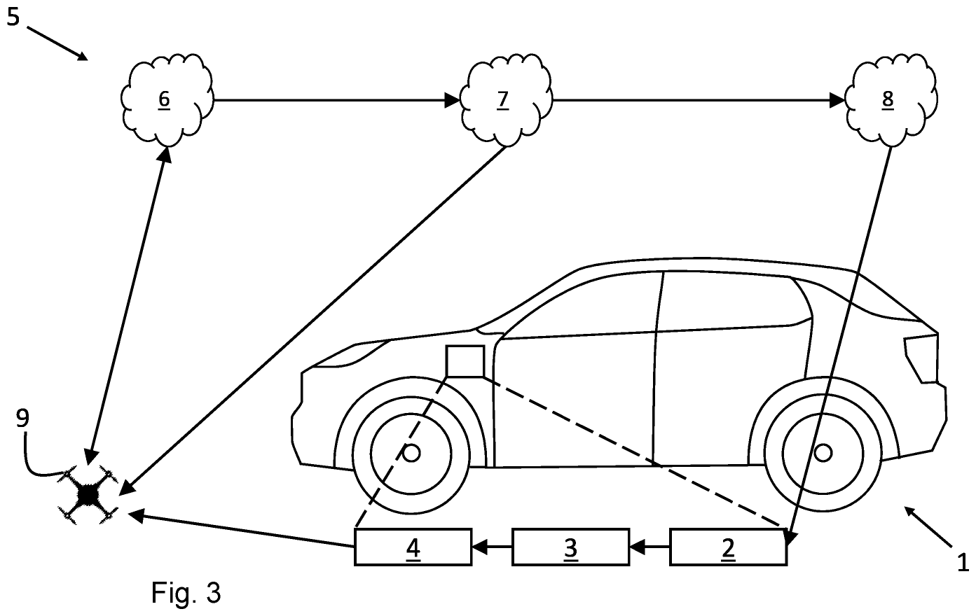

FIG. 3 schematically shows a vehicle 1 arranged to allow remote access to specific vehicle functions through network communication with a cloud service. The vehicle 1 comprises a telematics module (TEM) 2, a central electronic module (CEM) 3 and a Bluetooth Near Field Communication Module (BNCM) 4. These modules are all illustrated as located in one vehicle component; however, one or more of the modules may be located separate from the other in the vehicle. The modules are arranged to communicate with each other by wired or wireless communication according to any suitable communication protocol.

FIG. 3 also schematically show a cloud service 5 comprising a vehicle service booking 6, a vehicle access management system 7 and a telematics service provider 8. The cloud service 5 is configured for:
receiving information from a vehicle owner/user that a specific service of the vehicle is requested,
in response to the requested specific service, creating a new digital key or authenticating an existing digital key for a vehicle service provider 9, which provides the specific service requested, wherein the digital key comprises information arranged to allow remote access to a subset of a plurality of specific vehicle functions, which subset is associated with the specific service of the vehicle,
providing the vehicle service provider 9 with the new digital key or authentication of an existing digital key, allowing operation of the subset of specific vehicle functions by the vehicle service provider 9 for performing the specific service if the digital key is received.

In short, one way the cloud service can perform the above steps is by the following steps:
sending the new digital key or authentication of the existing digital key by a vehicle access management system 7 to a communication device associated with the vehicle service provider 9,
sending the new digital key or authentication of the existing digital key by a telematics service provider to a vehicle function access device in the vehicle,
verifying in the vehicle function access device that the new digital key or existing digital key allows operation of the subset of specific vehicle functions by the vehicle service provider 9.

The communication device in the car associated with the vehicle service provider 9 is for instance the TEM 2 or an Infotainment Head Unit (IHU), i.e. the unit connecting the car with the cloud.

Below follows a more detailed example of how the method can be performed. This is to be seen as a non-limiting example. Other ways to perform the method can be found in the application EP 21193831.1 filed on the same date by the applicant.

The vehicle service booking 6 is in network communication with the vehicle service provider 9, in FIG. 3 illustrated by an autonomous unit, such as an unmanned aerial vehicle (UAV). It is also possible for the vehicle service provider 9 to be an unmanned wheeled vehicle or an unmanned tracked vehicle as well as a human vehicle service provider such as a mechanic or rental car relocator driver. The vehicle service provider 9 is equipped with a communication device associated with the vehicle service provider 9. It is possible for each autonomous unit to receive a different digital key or to authenticate an existing digital key broadcasted by the autonomous unit comprising information arranged to allow access to a different subset of specific vehicle functions associated with each autonomous unit. In this way a multitude of autonomous units can perform a vehicle service such as cleaning the vehicle where one autonomous unit can be allowed to operate the vehicle lock, one autonomous unit can be allowed to operate moving of a vehicle seat, one autonomous unit can be allowed to operate a vehicle cleaning program etc. The method according to the disclosure is not limited in how many digital keys that can grant access to specific vehicle functions at the same time.

The vehicle service booking 6 is further in network communication with the vehicle access management system 7 and can relay orders for vehicle services from the vehicle service booking 6. The vehicle access management system 7 is in network communication with the vehicle service provider 9 to forward a new digital key created in response to a vehicle service-booking contract being received from the vehicle service booking 6 or authenticates an existing digital key for a vehicle service provider 9. The vehicle access management system 7 in turn sends the vehicle service booking contract information to the telematics service provider 8 that sends the vehicle service booking contract information to the vehicle's TEM 2. The TEM 2 unencrypts/re-encrypts the contract information and sends it to the CEM 3. The CEM 3 stores the digital key and contract information. The autonomous unit sends its digital key and a requested specific vehicle function command over Bluetooth® Low Energy (BLE) to the BNCM 4. The CEM 3, functioning as the vehicle function access device, verifies the digital key and the rights to the sent specific vehicle function command sent to the BNCM 4. The CEM 3 thereafter runs the command that operates the requested specific vehicle function.

The same principle applies to a situation where the vehicle service provider is replaced with a vehicle service user intending to use a specific service.

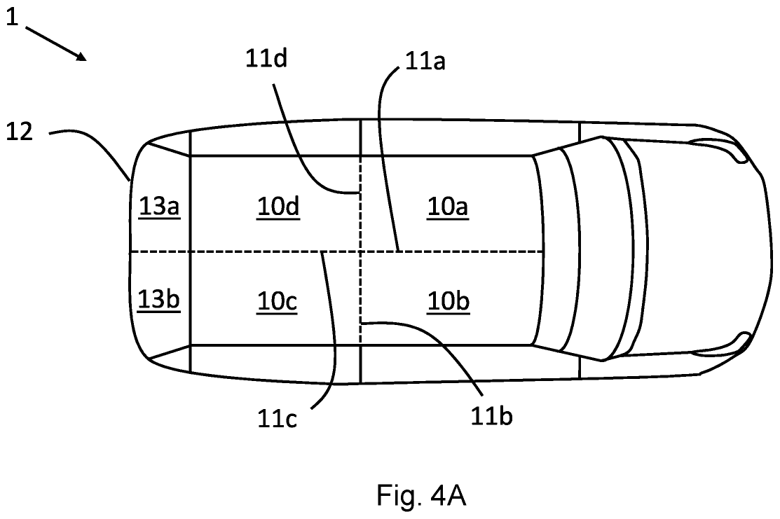

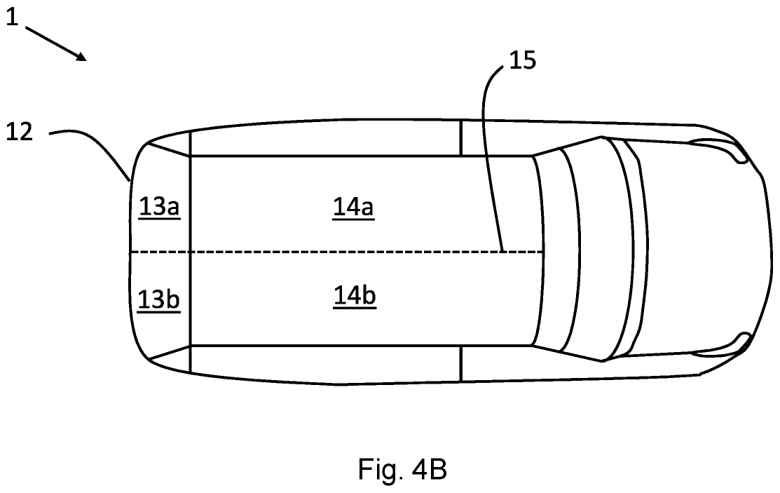

FIGS. 4A and 4B schematically show a top view of a vehicle 1 arranged to allow remote access to specific vehicle functions through communication with a cloud service similar to the vehicle 1 of FIG. 3.

The vehicle 1 is an autonomous or self-driving vehicle, which has been divided into four seating compartments 10a, 10b, 10c, 10d. Each seating compartment 10a, 10b, 10c, 10d comprises a seat and functions operable by an occupant of the seat such as door access, window control and air conditioning control specific for that seating compartment 10a, 10b, 10c, 10d. The different seating compartments 10a, 10b, 10c, 10d of the vehicle 1 are divided by raisable dividing walls 11a, 11b, 11c, 11d that can be raised and lowered to create different sized compartments, depending on if the occupants are familiar with each other or not. The trunk 12 is also divided into luggage compartments. In the non-limiting use example of FIG. 4A it is divided into two luggage compartments 13a, 13b. It is also possible to have one large luggage compartment in the trunk 12 if the vehicle 1 is divided into a single seating compartment, for instance when the vehicle 1 is shared among a family or a group of friends, or four smaller luggage compartments, one for each seating compartment 10a, 10b, 10c, 10d when the vehicle 1 is divided into four seating compartments 10a, 10b, 10c, 10d.

In one non-limiting use example as shown in FIG. 4A, a vehicle service user books a ride using an app on a mobile device. In the booking, a specific seating compartment 10a in a vehicle 1 divided into four seating compartments 10a, 10b, 10c, 10d is chosen. A new digital key is created or an existing digital key is authenticated which is identified by the vehicle 1. The vehicle 1 only allows access to the specific seating compartment 10a that was chosen in the booking and to a specific luggage compartment, if selected. The chosen seating compartment 10a is separated from the other seating compartments 10b, 10c, 10d by raisable dividing walls 11a, 11b, 11c, 11d so that travel is made safe, private and with space such that work can be performed. It is possible for each seating compartment 10a, 10b, 10c, 10d to comprise a vending machine with food, snacks and/or beverages or similar that can be used by the vehicle service user. At the destination, the vehicle service user exits the vehicle 1 and retrieves any luggage that was stored in the specific luggage compartment. The dividing wall 11c may extend into the trunk 12 of the vehicle, or the trunk 12 may have its own dividing walls that are operated independently of the dividing wall 11c of the seating compartments 10c, 10d to form the different luggage compartments of the vehicle 1.

In another non-limiting use example shown in FIG. 4B, two vehicle service users book an autonomous vehicle 1 for a long-distance business trip. A new digital key is created or an existing digital key is authenticated for each of the two vehicle service users that are identifiable by the vehicle 1. In this use example, the vehicle 1 is divided into two larger seating compartments 14a, 14b that can be changed from a seating configuration to a sleeping configuration. When in the seating configuration, a dividing wall 15 between the two seating compartments 14a, 14b can be lowered so that the occupants of the two seating compartments 14a, 14b can interact. When one or both of the occupants wants privacy, for instance to prepare a seating compartment for sleeping, the dividing wall 15 is raised to create the two separate seating compartments 14a, 14b. Each occupant only has access to the functions of their respective seating compartment 14a, 14b, while operation of the dividing wall 14 is shared between both occupants. The dividing wall 15 may extend into the trunk 12 of the vehicle, or the trunk 12 may have its own dividing walls that are operated independently of the dividing wall 15 of the seating compartments 14a, 14b to form the different luggage compartments of the vehicle 1.

In a further non-limiting use example (not shown), a vehicle service user requests a package delivery via an app in a mobile device. A vehicle with a number of locked storage compartments arrive at an ordered time. The vehicle service user is granted access to open and close only the ordered storage compartment. After the package is securely stored in the storage compartment, the vehicle leaves to deliver the package to the ordered address. At the ordered address, the recipient of the package has access to the same storage compartment and can retrieve the package.

Although the disclosure has been illustrated and described in detail in the drawings and foregoing description, such illustration and description are to be considered illustrative or exemplary and the disclosure is not limited to the disclosed example embodiments.

What is claimed is:

1. A method for allowing remote access to specific vehicle functions of a vehicle, wherein the method comprises:
receiving information from a vehicle owner/user that a specific service of the vehicle is requested,
in response to the requested specific service, creating a new digital key or authenticating an existing digital key for a vehicle service provider, which provides the specific service requested, or a vehicle service user using the specific service requested, wherein the digital key comprises information arranged to allow remote access to a subset of a plurality of specific vehicle functions, which subset is associated with the specific service of the vehicle,
allowing operation of the subset of specific vehicle functions by the vehicle service provider for performing the specific service or by the vehicle service user using the specific service if the digital key is received, and
restricting operation of the subset of specific vehicle functions by the vehicle service provider or vehicle service user to a specific part of the vehicle.

2. The method according to claim 1, wherein the method comprises:
changing dynamically the subset of specific vehicle functions that is allowed to be operated by the vehicle service provider for performing the specific service or by the vehicle service user, and/or
changing dynamically the subset of specific vehicle functions that is restricted to be operated by the vehicle service provider or vehicle service user to a specific part of the vehicle.

3. The method according to claim 1, wherein the method comprises:
allowing operation of a specific vehicle function of the subset of specific vehicle functions associated with a safety check by a vehicle function access device only if the safety check is passed upon requesting access to the specific vehicle function.

4. The method according to claim 3, wherein the method comprises:
assessing if the safety check is passed based on sensor feedback from one or more sensors arranged in the vehicle or on a vehicle service provider, wherein the sensor feedback is one or more of detection of a foreign object inside the vehicle, detection of a foreign object outside the vehicle or detection of a vehicle occupant.

5. The method according to claim 3, wherein the method comprises:
assessing if the safety check is passed based on detecting a safe location of the vehicle service provider or the vehicle service user in an area inside the vehicle or outside the vehicle associated with the specific vehicle function.

6. The method according to claim 1, wherein the method comprises:
providing the new digital key or existing digital key with information regarding a location associated with the specific service of the vehicle,
allowing operation of the subset of specific vehicle functions associated with the vehicle service provider or the vehicle service user only if the vehicle is determined to be in the location associated with the specific service of the vehicle.

7. The method according to claim 1, wherein the method comprises:
providing a time limit for expiration of the new digital key or existing digital key,
deactivating the new digital key or existing digital key upon expiration of the time limit.

8. The method according to claim 1, wherein the vehicle service provider is an autonomous unit, such as an unmanned aerial vehicle (UAV), an unmanned wheeled vehicle or an unmanned tracked vehicle.

9. The method according to claim 8, wherein each autonomous unit receives a different digital key or the car's vehicle access management system authenticating an existing digital key broadcasted by the autonomous unit comprising information arranged to allow access to a different subset of specific vehicle functions associated with each autonomous unit.

10. The method according to claim 1, wherein operation of specific vehicle functions include one or more of:
mechanically moving a vehicle component such as a door, window, retractable roof or hardtop, sunroof, hatch, or seat,
activating a specific vehicle function, such as a vehicle lock, a vehicle disinfection program, a vehicle cleaning program, an infotainment system, an air conditioning system and a vehicle sensor.

11. A method according to claim 1, wherein the method comprises:
sending the new digital key or authentication of the existing digital key by a vehicle access management system to a communication device associated with the vehicle service provider or the vehicle service user,
sending the new digital key or authentication of the existing digital key by a telematics service provider to a vehicle function access device in the vehicle,
verifying in the vehicle function access device that the new digital key or existing digital key allows operation of the subset of specific vehicle functions by the vehicle service provider or the vehicle service user.

12. A cloud service for providing remote access to specific vehicle functions of a vehicle, wherein the cloud service is configured for:
receiving information from a vehicle owner/user that a specific service of the vehicle is requested,
in response to the requested specific service, creating a new digital key or authenticating an existing digital key for a vehicle service provider, which provides the specific service requested, or a vehicle service user using the specific service requested, wherein the digital key comprises information arranged to allow remote access to a subset of a plurality of specific vehicle functions, which subset is associated with the specific service of the vehicle,
providing the vehicle service provider or the vehicle service user with the new digital key or authentication of an existing digital key, allowing operation of the subset of specific vehicle functions by the vehicle service provider for performing the specific service or by the vehicle service user using the specific service if the digital key is received, and
providing information arranged to allow remote access to a subset of a plurality of specific vehicle functions, wherein the operation of the subset of specific vehicle functions by the vehicle service provider or the vehicle service user is restricted to a specific part of the vehicle.

13. The cloud service according to claim 12, wherein the cloud service is configured for:
changing dynamically the subset of specific vehicle functions that is allowed to be operated by the vehicle service provider for performing the specific service or by the vehicle service user, and/or
changing dynamically the subset of specific vehicle functions that is restricted to be operated by the vehicle service provider or the vehicle service user to a specific part of the vehicle.

14. The cloud service according to claim 12, wherein the cloud service is configured for:
when creating a new digital key for the vehicle service provider or the vehicle service user,
sending the new digital key or authentication of the existing digital key by a vehicle access management system of the cloud service to a communication device associated with the vehicle service provider or the vehicle service user,
sending the new digital key or authentication of the existing digital key by a telematics service provider of the cloud service to a vehicle function access device in the vehicle,
verifying in the vehicle function access device that the new digital key or existing digital key allows operation of the subset of specific vehicle functions by the vehicle service provider or the vehicle service user.

15. The cloud service according to claim 12, wherein the specific service of the vehicle includes one or more of:
package delivery,
food delivery,
cleaning of the vehicle,
charging of the vehicle,
wheel change,
parking,
rental car relocation.
